(19) United States
(12) Patent Application Publication
(10) Pub. No.: US 2013/0147308 A1
(43) Pub. Date: Jun. 13, 2013

(54) SPINDLE MOTOR

(71) Applicant: Chang Jo YU, Gyunggi-do (KR)

(72) Inventor: Chang Jo YU, Gyunggi-do (KR)

(73) Assignee: SAMSUNG ELECTRO-MECHANICS CO., LTD., Suwon (KR)

(21) Appl. No.: 13/397,933

(22) Filed: Feb. 16, 2012

(30) Foreign Application Priority Data
Dec. 9, 2011 (KR) 10-2011-0131945

(51) Int. Cl. H02K 1/00; F16C 32/06

(52) U.S. Cl. 310/216.001; 384/107

(57) ABSTRACT

There is provided a spindle motor including: a base part having a lower end portion of a shaft fixed thereto; a rotating member rotatably installed with respect to the shaft and forming a bearing clearance with the shaft, the bearing clearance being filled with a lubricating fluid; a coupling member fixedly installed on the rotating member and including an inclined surface allowing an interface between the lubricating fluid filling the bearing clearance and air to be formed; and an upper thrust member fixed to the shaft so as to form the interface between the lubricating fluid and air, with the coupling member.

### CROSS-REFERENCE TO RELATED APPLICATIONS

This application claims the priority of Korean Patent Application No. 10-2011-0131945 filed on Dec. 9, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A fixed-shaft spindle motor in which a shaft having strong impact resistance is fixed to a case of a hard disk driving device is generally mounted in an information recording and reproducing device such as a hard disk driving device for a server.

That is, a shaft is fixedly installed in the spindle motor mounted in the hard disk driving device for a server in order to prevent information stored in the server from being damaged and becoming unrecordable or unreadable due to an external impact.

Meanwhile, since it is necessary for a spindle motor used for an enterprise hard disk driving device to have high reliability, maintenance of a certain amount of lubricating fluid which fills a fluid dynamic bearing assembly including a fixed type shaft is required.

To this end, a structure in which the lubricating fluid filling the fluid dynamic bearing assembly is separated and fills upper and lower portions of the fluid dynamic bearing assembly may be employed.

In addition, in order to reduce manufacturing costs, a sleeve and a rotor hub configuring a rotating member may be formed integrally.

However, as described above, in order to form the sleeve and the rotor hub to be integral, simultaneously with using a structure capable of maintaining an amount of the lubricating fluid filled within a fluid dynamic bearing assembly by separating the lubricating fluid and filling the upper and lower portions of the fluid dynamic bearing assembly therewith, as described above, the development of a new structure has been required.

That is, it is difficult to use a structure capable of separating the lubricating fluid and filling the upper and lower portions of the fluid dynamic bearing assembly therewith, while forming the sleeve and the rotor hub integrally.

In other words, the development of a structure capable of separating the lubricating fluid and filling the upper and lower portions of the fluid dynamic bearing assembly therewith, while forming the sleeve and the rotor hub integrally has been urgently demanded.

### SUMMARY OF THE INVENTION

An aspect of the present invention provides a spindle motor including a rotating member having a sleeve and a rotor formed integrally.

Another aspect of the present invention provides a spindle motor in which an inclined surface for forming a liquid-vapor interface between a lubricating fluid and air is easily manufactured.

According to an aspect of the present invention, there is provided a spindle motor including: a base part having a lower end portion of a shaft fixed thereto; a rotating member rotatably installed with respect to the shaft and forming a bearing clearance with the shaft, the bearing clearance being filled with a lubricating fluid; a coupling member fixedly installed on the rotating member and including an inclined surface allowing an interface between the lubricating fluid filling the bearing clearance and air to be formed; and an upper thrust member fixed to the shaft so as to form the interface between the lubricating fluid and air, with the coupling member.

The rotating member may include a sleeve part forming the bearing clearance filled with the lubricating fluid and a rotor hub part extended from an upper end portion of the sleeve part.

The sleeve part may include an installation groove formed in an upper surface thereof such that the coupling member is inserted therein.

The coupling member may have a circular ring shape and include the inclined surface provided on an outer peripheral surface thereof, the inclined surface having a diameter larger in an upper end portion thereof than in a lower end portion thereof.

The shaft may include a depression groove allowing the interface between the lubricating fluid and air to be formed so that the lubricating fluid is separated and fills upper and lower portions of the bearing clearance.

The rotating member may include a communication hole allowing a space formed by the depression groove and the rotating member and the outside to be in communication with each other.

The rotating member may include a sleeve part coupled to the coupling member to form the bearing clearance together with the shaft, the bearing clearance being filled with the lubricating fluid, and a rotor hub part extended from the sleeve part.

The coupling member may have a hollow cylindrical shape such that the coupling member is coupled to the rotating member to form the bearing clearance with the shaft, and may include the inclined surface formed on an upper end portion of an outer peripheral surface thereof.

The shaft may include a depression groove allowing the interface between the lubricating fluid and air to be formed so that the lubricating fluid is separated and fills upper and lower portions of the bearing clearance, and the coupling member and the sleeve part may include communication parts formed therein in order to allow a space formed together with the depression groove and the outside to be in communication with each other.

The base part may include a base member having a stator core installed thereon, and a lower thrust member fixed to the base member and having the lower end portion of the shaft fixed thereto.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is a perspective view showing a coupling member provided in the spindle motor according to the embodiment of the present invention;

FIG. 3 is an enlarged view showing part A of FIG. 1;

FIG. 4 is a schematic cross-sectional view showing a spindle motor according to another embodiment of the present invention;

FIG. 5 is a partially cut-away exploded perspective view showing a rotating member and a coupling member of the spindle motor according to another embodiment of the present invention; and

FIG. 6 is an enlarged view showing part B of FIG. 4.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

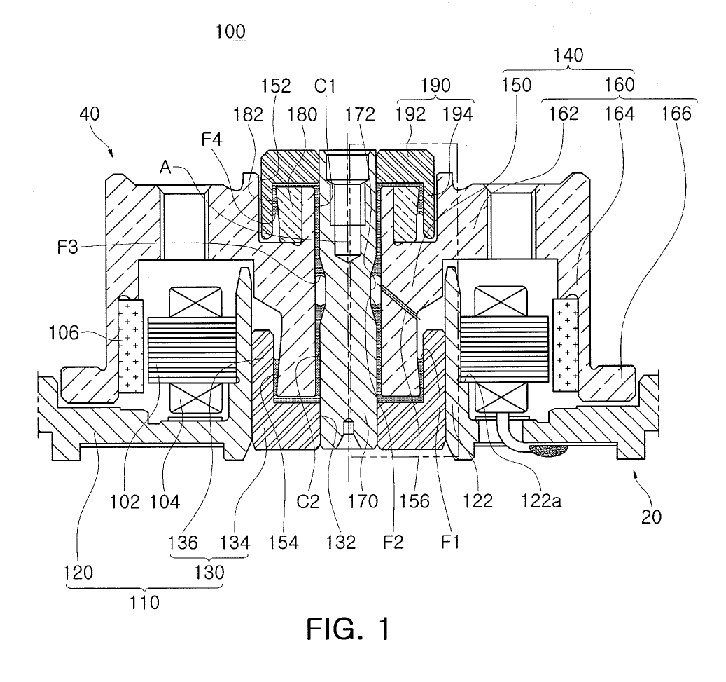

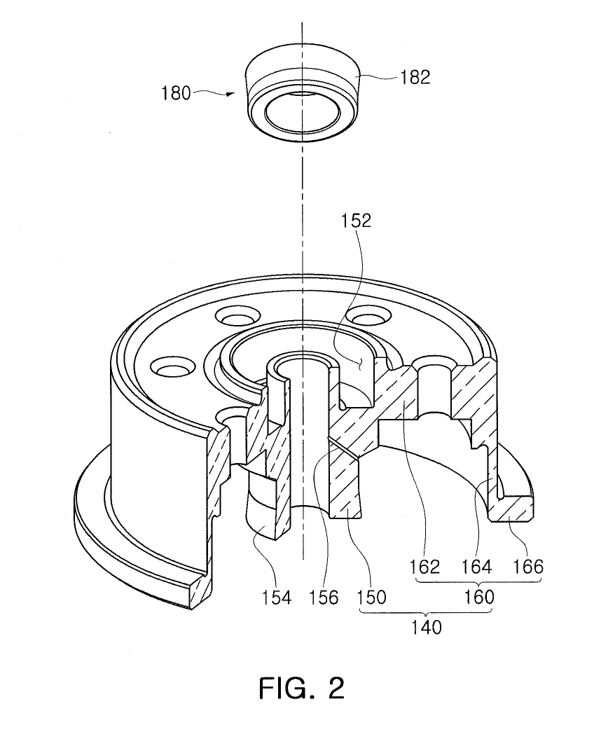

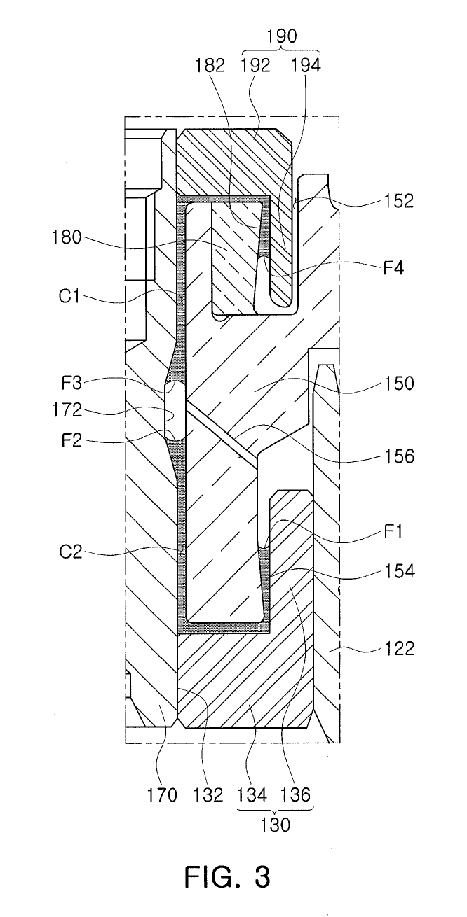

FIG. 1 is a schematic cross-sectional view showing a spindle motor according to an embodiment of the present invention. FIG. 2 is a perspective view showing a coupling member provided in the spindle motor according to the embodiment of the present invention. FIG. 3 is an enlarged view showing part A of FIG. 1.

Referring to FIGS. 1 through 3, a spindle motor 100 according to the embodiment of the present invention may include a base part 110, a rotating member 140, a shaft 170, a coupling member 180, and an upper thrust member 190 by way of example.

Meanwhile, the spindle motor 100 according to the embodiment of the present invention may be a motor used in an information recording and reproducing device such as a hard disk driving device for a server, or the like.

In addition, the spindle motor 100 according to the embodiment of the present invention may be mainly configured of a stator 20 and a rotor 40.

The stator 20, which means all fixed members with the exception of rotating members, may include the base part 110, the shaft 170, the upper thrust member 190, and the like.

In addition, the rotor 40, which means members rotating around the shaft 170, may include the rotating member 140, the coupling member 180, and the like.

Here, terms with respect to directions will be defined. As viewed in FIG. 1, an axial direction refers to a vertical direction, that is, a direction from a lower portion of the shaft 170 toward an upper portion thereof or a direction from the upper portion of the shaft 170 toward the lower portion thereof, and a radial direction refers to a horizontal direction, that is, a direction from the shaft 170 toward an outer peripheral surface of the rotating member 140 or a direction from the outer peripheral surface of the rotating member 140 toward the shaft 170.

In addition, a circumferential direction refers to a rotation direction along an outer peripheral surface of the shaft 170 or the outer peripheral surface of the rotating member 140.

The base part 110 is a fixed member configuring the stator 20 as described above. A lower end portion of the shaft 170 may be fixed to base part 110.

In addition, the base part 110 may include a base member 120 having a stator core 102 installed thereon and a lower thrust member 130 fixed to the base member 120 and having the lower end portion of the shaft 170 fixed thereto.

The base member 120 may include a mounting part 122 in which the lower thrust member 130 is to be insertedly mounted. The mounting part 122 may be extended upwardly in the axial direction and have a mounting surface 122a provided on an outer peripheral surface thereof so as to allow the stator core 120 may be fixedly mounted thereon.

The lower thrust member 130, which is a fixed member included in the base part 110, may be fixed to the base member 120. That is, an outer surface of the lower thrust member 130 may be bonded to the base member 120 by an adhesive and/or welding.

In other words, the outer surface of the lower thrust member 130 may be bonded to an inner surface of the mounting part 122 of the base member 120.

In addition, the lower thrust member 130 may have a hollow cup shape. In addition, the lower thrust member 130 may include an installation hole 132 formed therein such that the lower end portion of the shaft 170 may be inserted therein and fixed thereto.

Meanwhile, the lower thrust member 130 may include a disk part 134 and an extension part 136 extended from an edge of the disk part 134 upwardly in the axial direction.

In addition, a first liquid-vapor interface F1 may be formed in a space formed by an inner peripheral surface of the extension part 136 and an outer peripheral surface of the rotating member 140.

In addition, a thrust dynamic pressure groove (not shown) for generating thrust fluid dynamic pressure may be formed in at least one of an upper surface of the disk part 134 and a facing surface of the rotating member 140 disposed to face the upper surface of the disk part 134.

Further, the lower thrust member 130 may also serve as a sealing member for preventing a lubricating fluid from being leaked.

The rotating member 140, a rotating member configuring the rotor 40 may be rotatably installed with respect to the shaft 170, and the rotating member 140 and the shaft 170 may form bearing clearances C1 and C2 filled with the lubricating fluid.

Meanwhile, the rotating member 140 may include a sleeve part 150 forming the bearing clearances C1 and C2 with the shaft 170, the bearing clearances C1 and C2 being filled with the lubricating fluid, and a rotor hub part 160 extended from an upper end portion of the sleeve part 150.

That is, in the rotating member 140, the sleeve part 150 and the rotor hub part 160 may be formed integrally.

The sleeve part 150 may form the bearing clearances C1 and C2 with the shaft 170, the lower thrust member 130, and the upper thrust member 190. In addition, these bearing clearances C1 and C2 may be filled with the lubricating fluid.

Here, the bearing clearances C1 and C2 will be described in more detail. The bearing clearances C1 and C2 may include an upper bearing clearance (denoted by C1) and a lower bearing clearance (denoted by C2).

In addition, the upper bearing clearance C1 means a space formed by an upper end portion of the shaft 170 and the upper end portion of the sleeve part 150 and a space formed by the upper end portion of the sleeve part 150 and the upper thrust member 190.

Further, the lower bearing clearance C2 means a space formed by the lower end portion of the shaft 170 and a lower end portion of the sleeve part 150 and a space formed by the lower end portion of the sleeve part 150 and the lower thrust member 130.

Meanwhile, the lubricating fluid may be separated and fill the upper and lower bearing clearances C1 and C2.

Further, the sleeve part 150 may include an installation hole 152 formed in an upper surface thereof such that the coupling part 180 may be inserted therein.

In addition, the sleeve part 150 may have an inclined part 154 formed on an outer peripheral surface of the lower end portion thereof so as to form an interface between the lubricating fluid filling the lower bearing clearance C2 and air, with the extension part 136 of the lower thrust member 130.

Therefore, the first liquid-vapor interface F1 between the lubricating fluid filling the lower bearing clearance C2 and air may be formed in a space formed by the inclined part 154 and the extension part 136 through a capillary phenomenon.

Further, the sleeve part 150 may include a radial dynamic pressure groove (not shown) formed in an inner surface thereof in order to generate fluid dynamic pressure at the time of rotation. The radial dynamic pressure groove may have a herringbone shape or a spiral shape and include upper and lower radial dynamic pressure grooves.

In addition, the rotor hub part 160 may include a hub part body 162 extended from an outer peripheral surface of the sleeve part 150, a magnet mounting part 164 extended from an edge of the hub part body 162 downwardly in the axial direction, and a disk mounting part 166 extended from the magnet mounting part 164 outwardly in radial direction.

In addition, the magnet mounting part 164 may include a driving magnet 106 mounted on an inner surface thereof. The driving magnet 106 may be mounted on the magnet mounting part 164 so as to be disposed to face a front end of the stator core 102.

Here, rotational driving of the rotating member 140 will be schematically described. When power is supplied to the coil 104 wound around the stator core 102, driving force capable of rotating the rotating member 140 may be generated by electromagnetic interaction between the driving magnet 106 and the stator core 102 having the coil 104 wound therearound.

Therefore, the rotating member 140 may rotate around the shaft 170. At this time, the rotating member 140 may pump the lubricating fluid filling the upper and lower bearing clearances C1 and C2 to form fluid dynamic pressure.

The shaft 170 may have the lower end portion fixed to the lower thrust member 130. In addition, the shaft 170 may include a depression groove 172 allowing the interface between the lubricating fluid and air to be formed in order that the lubricating fluid may be separated and fills the upper and lower bearing clearances C1 and C2.

That is, a lower end portion of the depression groove 172 may be provided with an interface between the lubricating fluid filling the lower bearing clearance C2 and air, that is, a second liquid-vapor interface F2, and an upper end portion of the depression groove 172 may be provided with an interface between the lubricating fluid filling the upper bearing clearance C1 and air, that is, a third liquid-vapor interface F3.

In addition, in order to form the second and third liquid-vapor interfaces F2 and F3, the upper and lower portions of the depression groove may be inclined. In other words, the upper end portion and the lower end portion of the depression groove 172 may be inclined such that the second and third liquid-vapor interfaces F2 and F3 may be formed by a capillary phenomenon.

Meanwhile, the sleeve part 150 may include a communication hole 156 allowing a space formed by the depression groove 172 and the sleeve part 150 and the outside to be in communication with each other. That is, the sleeve part 150 may be provided with the communication hole 156 allowing pressure in the space formed by the sleeve part 150 and the depression groove 172 to be the same as pressure in the outside, so as to form the second and third liquid-vapor interfaces F2 and F3 as described above.

As described above, the lubricating fluid may be separated and fill the upper and lower bearing clearances C1 and C2 by the depression groove 172 of the shaft 170 and the communication hole 156 of the sleeve part 150.

The coupling member 180 may be fixedly installed on the rotating member 140 and have an inclined surface 182 allowing an interface between the lubricating fluid filling the bearing clearance Cl and air to be formed. That is, the coupling member 180 may be inserted in the installation groove 152 formed in the upper surface of the sleeve part 150.

Here, the coupling member 180 may be inserted in the installation groove 152 by an adhesive and/or welding.

In addition, the coupling member 180 may have the inclined surface 182 formed on an outer peripheral surface thereof so as to form the interface between the lubricating fluid filling the upper bearing clearance C1 and air, that is, a fourth liquid-vapor interface F4, with the upper thrust member 190.

That is, the coupling member 180 having the inclined surface 182 may be installed on the rotating member 140 to form the fourth liquid-vapor interface F4 with the upper thrust member 190. More specifically, in the case in which the rotating member 140, that is, the sleeve part 150 and the rotor hub part 160 are formed integrally, an inclined surface may not formed on the upper portion of the sleeve part 150.

However, the coupling member 180 provided as a separate member and having the inclined surface 182 is installed on the rotating member 140, such that the inclined surface 182 may be formed to face the upper thrust member 190 to allow for the formation of the fourth liquid-vapor interface F4.

The upper thrust member 190 may be fixed to the shaft 170 so as to form the interface between the lubricating fluid and air, with the coupling member 180.

To this end, the upper thrust member 190 may include a body 192 having an inner surface bonded to the shaft 170 and a protrusion part 194 extended from the body 192 to thereby form the fourth liquid-vapor interface F4 with the inclined surface 182 of the coupling member 180.

The protrusion part 194 may be extended from an edge of the body 192 downwardly in the axial direction and inserted in the installation groove 152.

That is, the fourth liquid-vapor interface F4 may be formed in a space formed by the inclined surface 182 and the protrusion part 194.

Therefore, since an interval between the upper thrust member 190 and the installation groove 152 may be narrowed, preventing the air including an evaporated lubricating fluid from being leaked to the outside may be possible to thereby suppress a reduction in the lubricating fluid filling the upper bearing clearance C1.

In addition, the upper thrust member 190 may serve to prevent leakage of the lubricating fluid.

Meanwhile, a thrust dynamic pressure groove (not shown) for generating thrust fluid dynamic pressure at the time of rotation of the rotating member 140 may be formed in a lower surface of the upper thrust member 190, that is, a low surface of the body 192.

As described above, a structure in which the coupling member 180 having the inclined surface 182 is installed on the rotating member 140 is used, such that even in the case in which the sleeve part 150 and the rotor hub part 160 are manufactured integrally, the inclined surface 182 forming the fourth liquid-vapor interface F4 with the upper thrust member 190 may be formed.

As a result, since the sleeve part 150 and the rotor hub part 160 may be manufactured integrally, a manufacturing cost may be reduced.

In addition, the spindle motor 100 according to the embodiment of the present invention needs not include a separate sealing member for preventing the leakage of the lubricating fluid, such that a bearing span length may increase to improve rotational characteristics.

Here, the bearing span length indicates a distance between a region in which maximum dynamic pressure is generated while the lubricating fluid is pumped by the upper radial dynamic pressure groove (not shown) and a region in which maximum dynamic pressure is generated when the lubricating fluid is pumped by the lower radial dynamic pressure groove (not shown).

That is, the spindle motor 100 according to the embodiment of the present invention needs not include a separate sealing member, such that a portion in which a separate sealing member is installed is reduced, whereby a length of the sleeve part 250 may be increased to increase the bearing span length.

Hereinafter, a spindle motor according to another embodiment of the present invention will be described with reference to the accompanying drawings. However, a detailed description of the same components as the above-mentioned components will be omitted and be replaced by the above-mentioned description.

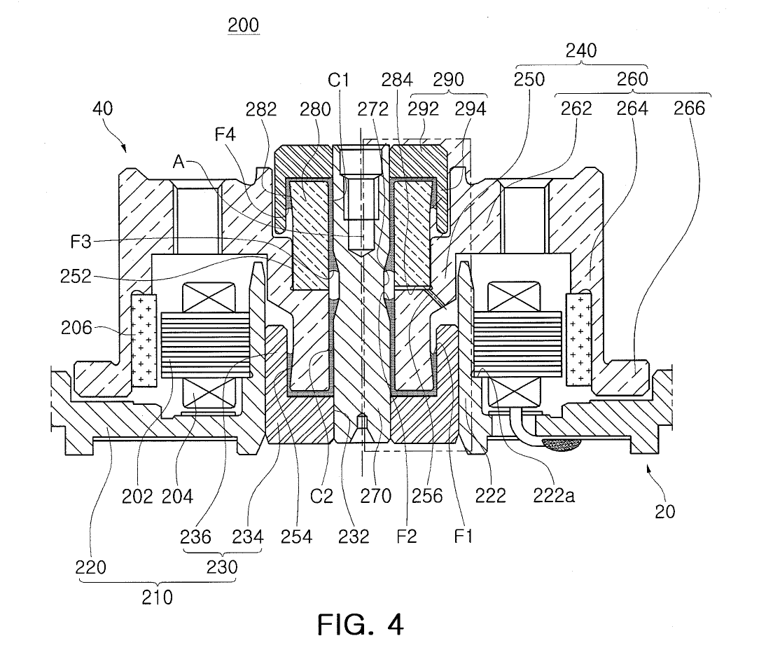

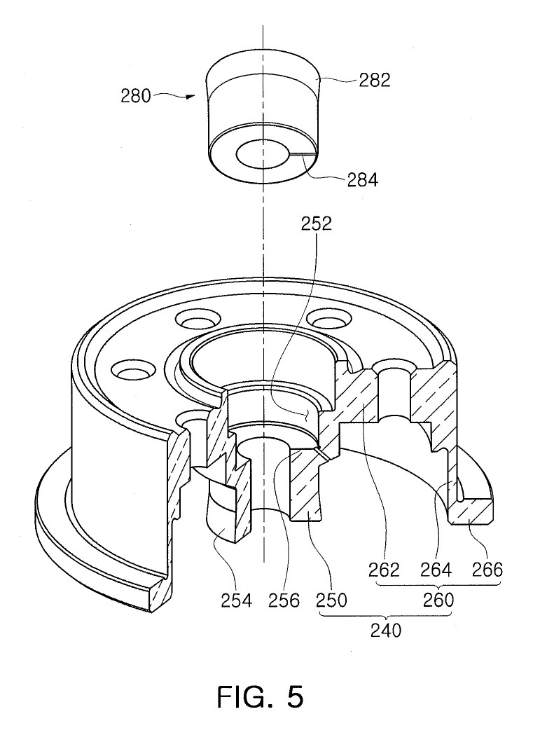

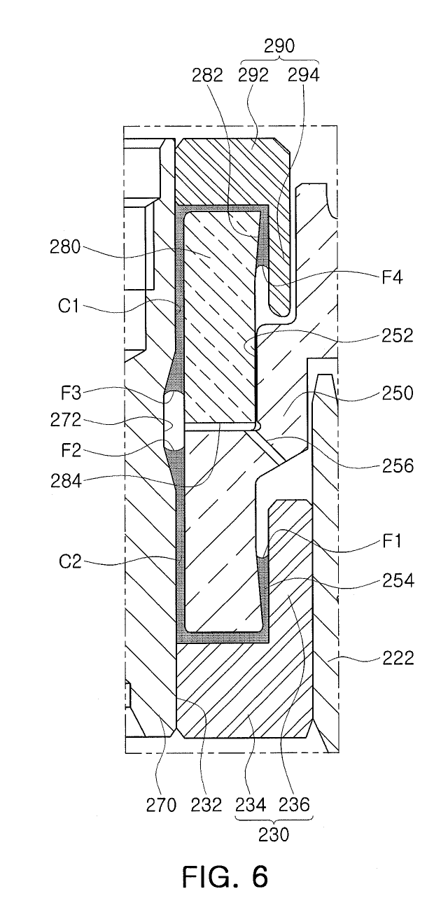

FIG. 4 is a schematic cross-sectional view showing a spindle motor according to another embodiment of the present invention. FIG. 5 is a partially cut-away exploded perspective view showing a rotating member and a coupling member of the spindle motor according to another embodiment of the present invention. FIG. 6 is an enlarged view showing part B of FIG. 4.

Referring to FIGS. 4 through 6, a spindle motor 200 according to another embodiment of the present invention may include a base part 210, a rotating member 240, a shaft 270, a coupling member 280, and an upper thrust member 290 by way of example.

In addition, the base part 210 may include a base member 220 having a stator core 202 installed thereon and a lower thrust member 230 fixed to the base member 220 and having the lower end portion of the shaft 270 fixed thereto.

Meanwhile, the base part 210 including the base member 220 and the lower thrust member 230, the shaft 270, and the upper thrust member 290 included in the spindle motor 200 according to another embodiment of the present invention have the same configurations as those of the base part 110, the shaft 170, and the upper thrust member 190 included in the spindle motor 100 according to the foregoing embodiment of the present invention. Therefore, a detailed description thereof will be omitted and be replaced by the above-mentioned description.

The rotating member 240 may include a sleeve part 250 coupled to the coupling member 280 and forming the bearing clearance C2 with the shaft 270, the bearing clearance C2 being filled with the lubricating fluid, and a rotor hub part 260 extended from the sleeve part 250.

In addition, the coupling part 280 may have a hollow cylindrical shape such that coupling part 280 may be coupled to the rotating member 240 to form the bearing clearance C1 with the shaft 270. The coupling part may have an inclined surface 282 formed on an upper end portion of an outer peripheral surface thereof.

More specifically, even in the spindle motor 200 according to another embodiment of the present invention, the bearing clearance may include the upper bearing clearance C1 and the lower bearing clearance C2.

In addition, the upper bearing clearance C1 means a space formed by an inner surface of the coupling member 280 and an upper end portion of the shaft 270 and a space formed by an upper surface of the coupling member 280 and the upper thrust member 290.

That is, the upper bearing clearance C1 may be formed by the coupling member 280.

Further, the lower bearing clearance C2 means a space formed by a lower end portion of the shaft 270 and the sleeve part 250 and a space formed by the lower end portion of the sleeve part 250 and the lower thrust member 230.

Meanwhile, the sleeve part 250 may have an inclined part 254 formed on an outer peripheral surface of the lower end portion thereof so as to form an interface between the lubricating fluid filling the lower bearing clearance C2 and air, with an extension part 236 of the lower thrust member 230.

Therefore, the first liquid-vapor interface F1 between the lubricating fluid filling the lower bearing clearance C2 and air may be formed in a space formed by the inclined part 254 and the extension part 236 through a capillary phenomenon.

In addition, the sleeve part 250 may include a step groove 252 provided in an upper end portion thereof and having the coupling member 280 fixed therein. That is, the coupling member 280 may be fixed in the step groove 252 to allow for the formation of the upper bearing clearance C1.

The lubricating fluid may be separated and fill the upper and lower bearing clearances C1 and C2.

That is, in order that the lubricating fluid may be separated and fill the upper and lower bearing clearances C1 and C2, the shaft 270 may include a depression groove 272 allowing the interface between the lubricating fluid and air to be formed.

In addition, the coupling member 280 and the sleeve part 250 may include communication parts 284 and 256 formed therein in order to allow a space formed by the depression groove 272 of the shaft 270, the coupling member 280, and the sleeve part 250, and the outside to be in communication with each other.

The communication part 284 formed in the coupling member 280 may be a groove formed in a lower surface of the coupling member 280, and the communication part 256 formed in the sleeve part 250 may be a hole.

In addition, in the case of coupling the coupling member 280 to the sleeve part 250, the communication part 284 formed in the coupling member 280 and the communication part 256 formed in the sleeve part 250 may be disposed to be in communication with each other.

A structure in which the coupling member 280 having the inclined surface 282 is installed on the rotating member 240 is used, such that the sleeve part 250 and the rotor hub part 260 maybe formed integrally, whereby a manufacturing cost may be reduced.

As set forth above, according to the embodiments of the present invention, through the coupling member, the inclined surface maybe easily manufactured and the sleeve part and the rotor hub part may be formed integrally.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base part having a lower end portion of a shaft fixed thereto;
a rotating member rotatably installed with respect to the shaft and forming a bearing clearance with the shaft, the bearing clearance being filled with a lubricating fluid;
a coupling member fixedly installed on the rotating member and including an inclined surface allowing an interface between the lubricating fluid filling the bearing clearance and air to be formed; and
an upper thrust member fixed to the shaft so as to form the interface between the lubricating fluid and air, with the coupling member.

2. The spindle motor of claim 1, wherein the rotating member includes a sleeve part forming the bearing clearance filled with the lubricating fluid and a rotor hub part extended from an upper end portion of the sleeve part.

3. The spindle motor of claim 2, wherein the sleeve part includes an installation groove formed in an upper surface thereof such that the coupling member is inserted therein.

4. The spindle motor of claim 1, wherein the coupling member has a circular ring shape and includes the inclined surface provided on an outer peripheral surface thereof, the inclined surface having a diameter larger in an upper end portion thereof than in a lower end portion thereof.

5. The spindle motor of claim 1, wherein the shaft includes a depression groove allowing the interface between the lubricating fluid and air to be formed so that the lubricating fluid is separated and fills upper and lower portions of the bearing clearance.

6. The spindle motor of claim 5, wherein the rotating member includes a communication hole allowing a space formed by the depression groove and the rotating member and the outside to be in communication with each other.

7. The spindle motor of claim 1, wherein the rotating member includes a sleeve part coupled to the coupling member to form the bearing clearance together with the shaft, the bearing clearance being filled with the lubricating fluid, and a rotor hub part extended from the sleeve part.

8. The spindle motor of claim 7, wherein the coupling member has a hollow cylindrical shape such that the coupling member is coupled to the rotating member to form the bearing clearance with the shaft, and includes the inclined surface formed on an upper end portion of an outer peripheral surface thereof.

9. The spindle motor of claim 8, wherein the shaft includes a depression groove allowing the interface between the lubricating fluid and air to be formed so that the lubricating fluid is separated and fills upper and lower portions of the bearing clearance, and
the coupling member and the sleeve part include communication parts formed therein in order to allow a space formed together with the depression groove and the outside to be in communication with each other.

10. The spindle motor of claim 1, wherein the base part includes a base member having a stator core installed thereon, and a lower thrust member fixed to the base member and having the lower end portion of the shaft fixed thereto.
